(19) United States
(12) Patent Application Publication
(10) Pub. No.: US 2016/0109928 A1
(43) Pub. Date: Apr. 21, 2016

(54) INTEGRATED CIRCUIT AND LOW POWER METHOD OF OPERATION

(71) Applicants: Yedong He, Suzhou (CN); Zhihong Wang, Suzhou (CN)

(72) Inventors: Yedong He, Suzhou (CN); Zhihong Wang, Suzhou (CN)

(21) Appl. No.: 14/556,227

(22) Filed: Nov. 30, 2014

(30) Foreign Application Priority Data
Oct. 16, 2014 (CN) 201410546625.8

(51) Int. Cl. G06F 1/32; G06F 13/38; G06F 5/14; G06F 13/28

(52) U.S. Cl. CPC G06F 1/3237; G06F 13/28; G06F 13/385; G06F 5/14; G06F 1/3287; G06F 1/3293

(57) ABSTRACT

A system-on-chip device operates in a low power mode and keeps on-board peripherals such as FIFO registers operational by maintaining a low frequency bit clock and gating other clock sources. When a peripheral device initiates a DMA (direct memory access) operation, the SOC's bus clock is enabled in response to a signal generated by the peripheral. Once data has been moved between the peripheral and system memory, the bus clock can be gated again.

### BACKGROUND OF THE INVENTION

The present invention relates generally to integrated circuits and, more particularly, to a system on chip and a method for reducing power consumption by controlling the gating of certain clock signals thereof.

A typical system on chip (SOC) includes one or more processing units (cores), memory, clock generators and a number of peripherals, as well as other functional modules, all of which consume power. Keeping power consumption at an acceptable level is becoming more challenging as data speeds increase and as more functional modules are integrated onto the chip. Clock gating of elements of an SOC that are inactive at any one time is one known way of managing power consumption but there is still a need for improvement in this area.

Thus it would be advantageous to provide a means for reducing power consumption in an SOC and similar devices.

### BRIEF DESCRIPTION OF THE DRAWINGS

The invention, together with objects and advantages thereof, may best be understood by reference to the following description of preferred embodiments together with the accompanying drawings in which:

FIG. 1 is a simplified, schematic block diagram of a system-on-chip (SOC) in accordance with an embodiment of the invention;

FIG. 2 is a schematic block diagram of a sub-set of modules of the SOC of FIG. 1, which sub-set includes low power control circuitry; and

FIG. 3 is a flow chart of a method of operating a SOC in accordance with one embodiment of the invention.

### DETAILED DESCRIPTION OF PREFERRED EMBODIMENTS

The detailed description set forth below in connection with the appended drawings is intended as a description of presently preferred embodiments of the invention, and is not intended to represent the only forms in which the present invention may be practised. It is to be understood that the same or equivalent functions may be accomplished by different embodiments that are intended to be encompassed within the spirit and scope of the invention. In the drawings, like numerals are used to indicate like elements throughout. Furthermore, terms “comprises,” “comprising,” or any other variation thereof, are intended to cover a non-exclusive inclusion, such that module, circuit, device components, structures and method steps that comprises a list of elements or steps does not include only those elements but may include other elements or steps not expressly listed or inherent to such module, circuit, device components or steps. An element or step proceeded by “comprises . . . a” does not, without more constraints, preclude the existence of additional identical elements or steps that comprises the element or step.

In one embodiment, the present invention provides a method of operating an integrated circuit. In a first mode of operation, data is exchanged between a peripheral device internal to the integrated circuit and a remote device external to the integrated circuit under the control of a bit rate clock signal while a bus clock signal is disabled. In a second mode of operation, the bus clock signal is enabled and data is exchanged between the peripheral device and a system memory internal to the integrated circuit under the control of the bus clock signal.

In another embodiment, the present invention provides control circuitry for an integrated circuit. The control circuitry comprises a peripheral device arranged to exchange data with an external device under the control of a received bit rate clock signal in a first mode of operation and to exchange data with a system memory under the control of a received bus clock signal in a second mode of operation. The control circuitry also comprises a clock gating module for disabling a system clock signal and the bus clock signal in the first mode of operation, and enabling the bus clock signal in the second mode of operation in response to a control signal generated by the peripheral device.

In another embodiment, the invention provides an integrated circuit comprising: a system clock generator for generating at least one system clock signal; a clock gating module for enabling and disabling system clock signals; and a peripheral device. The integrated circuit is operable in a low power mode in which the system clock signals are disabled. The peripheral device is arranged, while the integrated circuit is operating in said low power mode, to generate control signals for application to the clock gating module for enabling a system clock signal that is required by the peripheral device for performing a task, and for disabling the system clock signal after completing the task.

Thus, the peripheral device itself is able to decide which clocks to enable or disable without any CPU involvement. The peripheral device also can initiate a transition from a first mode of operation to a second mode of operation by generating a request signal that is asserted at the clock gating module. De-assertion of the request signal by the peripheral device initiates a transition from the second to the first mode of operation. The clock gating module enables or disables the bus clock signal depending on whether the request signal is being asserted or de-asserted. In one embodiment, the system clock signal remains gated during both first and second operating modes and is only enabled when a processing unit of the integrated circuit needs to be woken up.

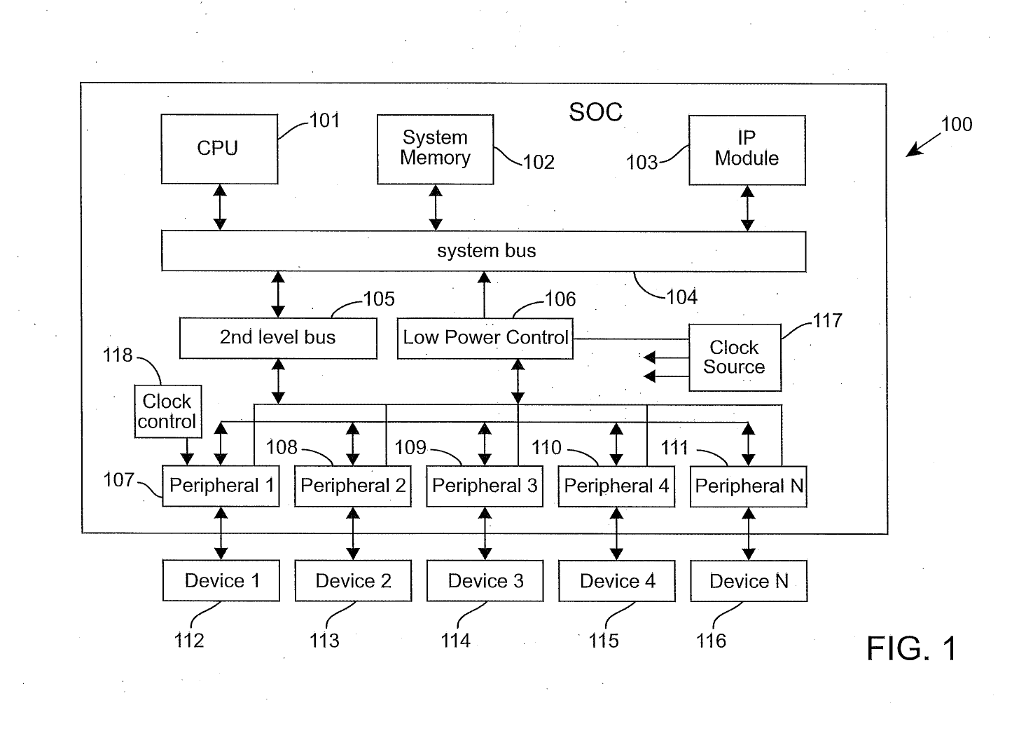

Referring now to FIG. 1, an SOC 100 is shown. SOCs like the exemplary device 100, often integrate many low speed peripherals which, in turn, communicate with off-chip devices. These peripherals make batch data exchanges with the SOC system memory during periods when the low speed peripherals are operational. Direct memory access (DMA) is used to assist in moving data from a peripheral's FIFO (First Input First Out) register into system memory or, conversely, from the system memory to the FIFO register and via a system bus in each case. System bus speed is typically relatively high (for example 100 Mhz), often several hundred times the speed of the peripheral. Thus, the system bus and functional blocks (other than peripherals) are often idle when peripherals are exchanging data with external (‘off-chip’) devices. Conventional methods maintain all of the SOC clocks while peripherals and external devices are exchanging data. These clocks typically comprise a bus clock, a CPU clock, a platform clock, a source clock, and a bit rate clock. The inventors have appreciated that as long as a peripheral's FIFO register is not empty or full, only the peripheral's bit rate clock needs to be enabled.

Advantageously, by employing the methods of one embodiment of the invention, while data is being exchanged between a system memory and a peripheral device under the control of a bus clock signal, data exchanges can also continue between the peripheral device and an external device under the control of a bit rate clock signal.

Referring again to FIG. 1, the SOC 100 includes a central processing unit (CPU) 101, a system memory 102 and other functional (IP) modules 103. A system bus 104 is operably coupled to the CPU 101, system memory 102 and IP module 103. Also operably coupled to the system bus 104 is a second level bus 105 (for peripheral register access) and a low power control module 106. The CPU 101 may comprise processing circuitry, as is known in the art, and may be a core processor, or comprise more than one core processor.

The SOC 100 also includes a plurality of peripherals (peripheral 1, 2, 3, 4, N), five of which 107-111 are shown in FIG. 1. Each of the peripherals 107-111 is operably coupled to the second level bus 105 and can therefore communicate with any of the CPU 101, system memory 103 and IP module 103 via the second level bus 105 and the system bus 104. Each peripheral 107-111 is also operably coupled to the low power control module 106. Each peripheral 107-111 can communicate with an associated device (Device 1, 2, 3, 4, N) 112-116 respectively, these devices 112-116 being external to the SOC 100. In a typical example, a peripheral 107 includes a FIFO register and operates to transfer data between its associated device 112 and the system memory 102 of the SOC. The peripheral 107 typically employs direct memory access for moving data to and from system memory 102.

The SOC 100 also includes a clock source module 117 that can act as a reference clock for the generation of the various clock signals required by the various functional modules comprising the SOC 100. Such clock signals typically include CPU (or system) clock, bus clock, platform clock and bit rate clock. The bit rate clock is serial clock that has one cycle per data bit sample. It is needed in order to synchronize an ‘on chip’ peripheral with an ‘off chip’ device. A typical value for the bit rate clock signal is 10MHz or less. Typically, when in a master mode, a peripheral outputs a bit rate clock derived from an on-chip clock reference to the off-chip device. When in a slave mode, the off-chip device outputs the bit rate clock to the on-chip peripheral via the ‘PAD IO.’ A peripheral uses the bit rate clock to shift bit data from/to its FIFO register.

An output of the clock source 117 is operably coupled to the low power module 106. Each peripheral 107-111 has an associated clock control module operably coupled thereto. Just one clock control module 118 is shown in FIG. 1 (for the sake of clarity) which provides a bit rate clock input to the (first) peripheral 107.

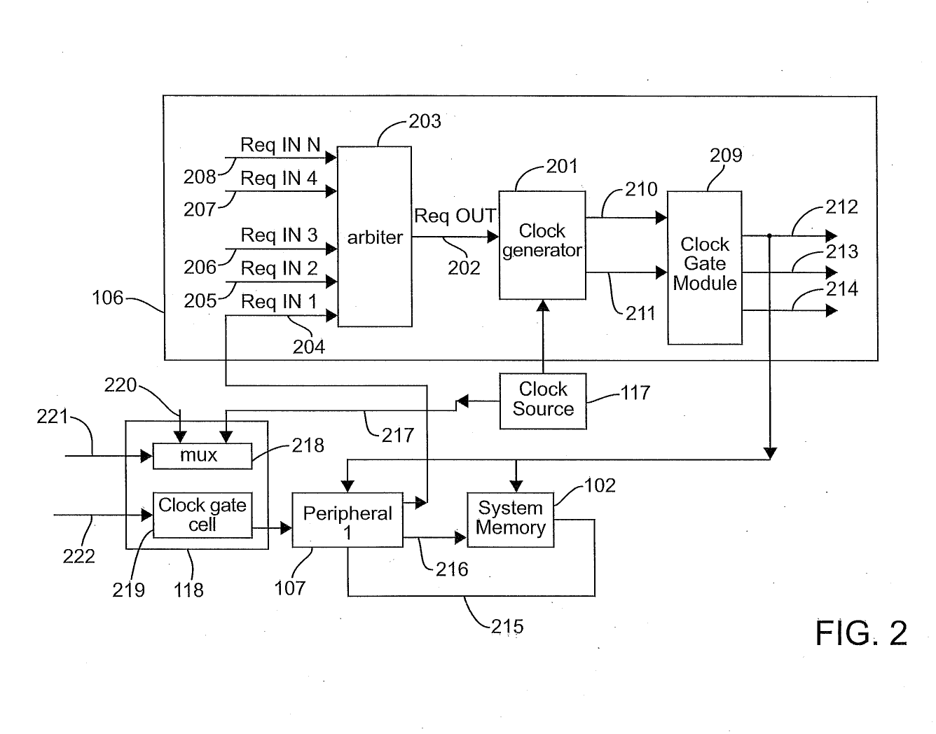

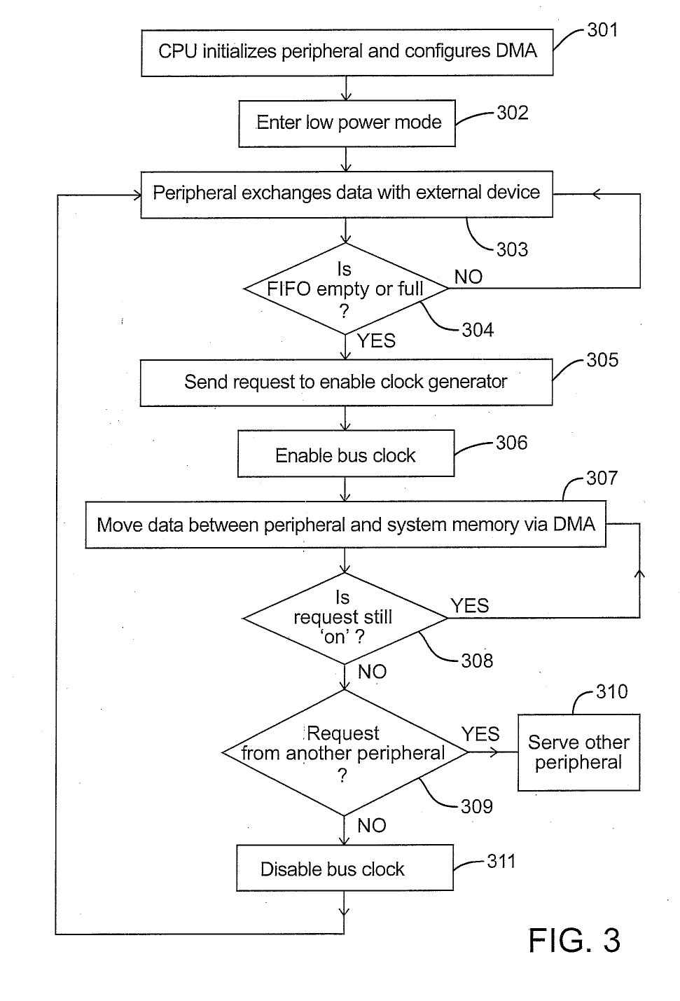

Referring now to FIG. 2, a subset of the modules of the SOC 100 is shown in greater detail. The low power control module 106 includes a clock generator 201 that receives a clock signal from a first output of the clock source module 117. This first output of the clock source module can have a typical frequency of 100MHz. In an alternative embodiment, the clock generator 201 receives the clock signal from an external source (not shown). The clock generator 201 is controlled by an output request signal ‘Req OUT’ on line 202 that it receives from an output of an arbiter 203 that is included in the low power module. The arbiter 203 is operably coupled to each peripheral 107-111 (only one being shown in FIG. 2) by a respective request input line ‘Req IN 1, Req IN 2, through to Req IN N on lines 204-208. Operation of the arbiter 203 will be described in detail below with reference to FIG. 3.

The low power control module 106 also includes a clock gate module 209, which can include one or more clock gate cells (not shown). The clock gate module receives, from the clock generator 201, a ‘source clock’ on line 210 and gate/enable signal on line 211. In one embodiment, the ‘source clock’ output comprises several clock signals. In one example, the clock generator outputs a CPU clock (for clocking the CPU 101), a platform clock and a bus clock. Each of these clock signals can be independently gated or enabled by the clock gate module 209 in response to the gate/enable signal on line 211. Thus, under certain operating conditions, the clock gate module 209 can output a CPU clock, platform clock and/or bus clock signal on output lines 212, 213 and 214 respectively. In a full power mode of operation, all clocks (bus clock, CPU clock and platform clock are enabled. In a low power mode of operation, all clocks are gated off unless a Req OUT signal on line 202 is raised by the arbiter 203, in which case, the bus clock (only) is enabled. Gating and enabling of the clock signals is controlled by the Req IN signal that is generated by the peripheral 107. Requests from any peripheral are arbitrated into the Req OUT output on line 202. This output is mapped into different events which can be used to gate a clock directly. Such requests made by peripherals are made in the bit rate clock domain and so can be generated even when the bus clock is gated off.

Typically, a CPU clock frequency, platform clock and bus clock frequency are all 100MHz. The bus clock signal line 212 is connected to a first input of each peripheral (one peripheral 107 only is shown in FIG. 2) and also to the system memory 102. The peripheral uses the bus clock signal when transferring data to and from system memory 102 using a DMA process. Each peripheral 107 can communicate with the system memory 102 over a data channel connection 215. Each peripheral 107 can make a request for DMA over a second (DMA Req) link 216 between each peripheral 107 and the system memory 102. This particular request is made in the bus clock domain and so can be generated only when the bus clock is enabled.

A second output 217 of the clock source 117 is fed to each clock control module 118 and provides a first bit rate clock signal (of typically 10MHz or less) that the peripheral 107 uses when it is operating in a ‘master’ mode. In this example, a clock control module 118 comprises a 2:1 multiplexer 218 and a clock gate cell 219. Data inputs of the multiplexer 218 comprise the second output 217 of clock source output and a second bit rate clock signal on line 220. The second bit rate clock signal is provided by the external device 112 associated with the peripheral 107 and is used by the peripheral 107 when operating in a ‘slave’ mode. A ‘select’ input for the multiplexer 218 is provided on line 221 from an ‘on chip’ peripheral master/slave mode register (not shown). A second, control input of the clock gate cell on line 222 comprises a ‘peripheral enable/disable” signal which is generated by an ‘on-chip’ peripheral enable register (not shown). An output of the clock gate cell 219 is connected to the peripheral 107 and provides the bit rate clock for the peripheral.

An example of a method for operating the SOC 100 of FIG. 1 will now be described with reference to the flow chart of FIG. 3 and to FIGS. 1 and 2. In particular, the exemplary method includes operating a peripheral 107 in a low power mode for low speed data transmission, whereby the peripheral continues to operate using the bit clock while all other clocks are gated off. Advantageously, the peripheral itself (rather than the CPU) initiates re-instatement of the bus clock if it needs to move data with DMA involvement. This is in contrast with known systems which require CPU involvement and therefore the CPU clock to be enabled.

At 301, the CPU 101 initializes the peripheral 107 and configures DMA in accordance with conventional methods. This step enables the peripheral 107 for data transmission with its external device 112.

At 302, the SOC enters a low power mode. In this mode, the CPU clock, bus clock and platform clock are gated off and only the bit rate clock, supplied to the peripheral 107 is running.

So in this mode, at 303, the peripheral 107 can still continue to operate, exchanging data with an external device 112 using the bit rate clock.

At 304, it is determined by the peripheral if its FIFO register is either empty or full or only part-full. If the register is neither empty nor full, then the peripheral continues to run on the bit rate clock. If on the other hand, the FIFO register is determined to be empty (or full), then this means that a DMA operation needs to be carried out in order to move data to (or from) system memory. This operation requires that the bus clock be provided to the peripheral 107 (and to the system memory 102).

So at 305, the peripheral raises a request message (Req IN 1) which it sends to the arbiter 203 (on line 204). This request message indicates to the arbiter that a DMA process is required. It will be understood that other enabled peripherals may also raise requests (Req IN 2 to N) at any time which will be received by the arbiter on any other one of its input lines 205-208. Such requests may also be for the re-instatement of the bus clock or could be for re-instatement of another clock such as the CPU or platform clock. The arbiter 203 selects a winning input for servicing and generates a Req OUT signal on line 202 which enables the clock generator 201 and is promulgated through to the clock gate module 209 and has the effect of enabling the bus clock (on line 212) but gating off the CPU and platform clock. Thus, at 306 the bus clock is enabled and all peripherals (and the system memory 102) which are connected to the low power control module 106 receive the bus clock. The arbiter can operate on a fixed or programmable priority for selecting a winning input.

As soon as the bus clock is enabled, at 307, data is moved between the peripheral and the system memory 102 via DMA. This is in contrast with conventional systems where in order to perform this step, the entire SOC system is woken up and all clocks are enabled.

At 308, it is determined whether or not the Req IN 1 signal generated by the peripheral is still being asserted. If so, then the method loops back to 307 and data continues to be moved between the peripheral 107 and the system memory 102 via DMA.

When the Req IN 1 signal is de-asserted, (because the peripheral 107 no longer requires a DMA operation), then at 309, the arbiter 203 checks its inputs to determine if another peripheral has raised a request Req IN 2-N. If so, then the arbiter services that particular request at 310.

If there are no other requests to service, then at 311 the bus clock is gated off and the clock generator can also be disabled. The method can then revert to 303 where enabled peripherals continue to run on the bit rate clock only until one needs to move data to or from the system memory 102 and a Req IN signal is raised again. Then the method flow can repeat from 304 through to 311.

Advantageously, there is no need to wake up the CPU 101 (and run all clocks) in order to move data using a DMA operation is the case in known systems. Thus, an overall power saving can be achieved. An interrupt may wake up the CPU when it is required to perform a calculation, for example.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “de-assert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Further, the entire functionality of the modules shown in FIGS. 1 and 2 may be implemented in an integrated circuit. Such an integrated circuit may be a package containing one or more dies. Alternatively, the examples may be implemented as any number of separate integrated circuits or separate devices interconnected with each other in a suitable manner. An integrated circuit device may comprise one or more dies in a single package with electronic components provided on the dies that form the modules and which are connectable to other components outside the package through suitable connections such as pins of the package and bond wires between the pins and the dies.

The description of the preferred embodiments of the present invention has been presented for purposes of illustration and description, but is not intended to be exhaustive or to limit the invention to the forms disclosed. It will be appreciated by those skilled in the art that changes could be made to the embodiments described above without departing from the broad inventive concept thereof. It is understood, therefore, that this invention is not limited to the particular embodiment disclosed, but covers modifications within the spirit and scope of the present invention as defined by the appended claims.

1. A method of operating an integrated circuit device, the method comprising:
exchanging data between a peripheral device internal to the integrated circuit and a remote device external to the integrated circuit under the control of a bit rate clock signal;
disabling a bus clock signal in a first mode of operation; and
enabling the bus clock signal and exchanging data between the peripheral device and system memory under the control of the bus clock signal in a second mode of operation.

2. The method of claim 1, further comprising:
initiating a transition from the first mode to the second mode by generating and asserting a request signal; and
in response to receipt of the asserted request signal, enabling the bus clock signal.

3. The method of claim 2, further comprising:
initiating a transition from the second mode to the first mode by de-asserting the request signal; and
in response to receipt of the de-asserted request signal, disabling the bus clock signal.

4. The method of claim 2, further comprising generating the request signal in the peripheral device.

5. Control circuitry for an integrated circuit device, the control circuitry comprising:
a peripheral device arranged to exchange data with an external device under the control of a received bit rate clock signal in a first mode of operation, and to exchange data with a system memory under the control of a received bus clock signal in a second mode of operation; and
a clock gating module for disabling the bus clock signal in the first mode of operation, and enabling the bus clock signal in the second mode of operation in response to a control signal generated by the peripheral device.

6. The control circuitry of claim 5, wherein the peripheral device generates and asserts a request signal for receipt by the clock gating module for initiating a transition from the first mode to the second mode, and wherein the clock gating module enables the bus clock signal.

7. The control circuitry of claim 6, wherein the peripheral device de-asserts the request signal for initiating a transition from the second mode to the first mode, and wherein the clock gating module disables the bus clock signal.

8. The control circuitry of claim 5, wherein the peripheral device includes a First-In-First-Out (FIFO) register and wherein a request signal is generated when the FIFO register is empty or full.

9. An integrated circuit device capable of operating in a low power mode, the integrated circuit device comprising:
a system clock generator for generating at least one system clock signal;
a clock gating module for enabling and disabling the at least one system clock signal, wherein the at least one system clock signal is disabled in the low power mode; and
a peripheral device, wherein in the low power mode, the peripheral device generates control signals that are provided to the clock gating module for enabling a system clock signal that is required by the peripheral device for performing a task, and for disabling the system clock signal after completing the task.
